(19) United States
(12) Patent Application Publication
(10) Pub. No.: US 2025/0119270 A1
(43) Pub. Date: Apr. 10, 2025

(54) METHODS, SYSTEMS, AND COMPUTER READABLE MEDIA FOR CORRELATING AND DISPLAYING PHYSICAL LAYER AND APPLICATION LAYER TIMING INFORMATION

(71) Applicant: Keysight Technologies, Inc., Santa Rosa, CA (US)

(72) Inventors: Noah Steven Gintis, Westlake Village, CA (US); Pinaki Chakrabarti, League City, TX (US)

(21) Appl. No.: 18/378,113

(22) Filed: Oct. 9, 2023

(51) Int. Cl. H04L 7/02; H04J 3/06

(52) U.S. Cl. CPC H04L 7/02; H04J 3/0667

(57) ABSTRACT

A method for correlating and displaying physical layer and application layer timing information includes detecting an edge transition of a physical layer waveform from a physical clock on a DUT and generating a timestamp for the detected edge transition. A physical clock timing error is determined based on the timestamp for the detected edge transition. Timing protocol messages are exchanged between the test system and the DUT. The test system generates timestamps when transmitting or receiving the timing protocol messages and receives timestamp information from the DUT and a protocol time is determined. The physical clock timing error and the protocol time are correlated and relative times of the physical clock timing error and the protocol time are determined. The method further includes displaying, by a graphical user interface on the test system, a graphical representation of the relative times of the physical clock timing error and the protocol time.

### TECHNICAL FIELD

The subject matter described herein relates to timing information for network devices. More specifically, the subject matter relates to methods, systems, and computer readable media for correlating and displaying physical layer and application layer timing information.

### BACKGROUND

Oscilloscopes are commonly used to measure the attributes of signals, for example voltage levels, phases, and frequency, that are communicated between network devices. For example, a traditional oscilloscope can be used to detect and report the rising edge or falling edge of a physical signal. Such a physical signal may be used as a reference clock signal whose waveform is simultaneously transmitted to a collection of network devices and subsequently used to synchronize operations within these devices.

In environments where a common clock signal cannot be physically transmitted to the collection of network devices, application layer timing protocols (e.g., PTP, etc.) may be implemented and used to establish and maintain synchrony among the collection of network devices. Such application layer timing protocols exchange a series of messages that include clock timestamp information.

While oscilloscopes can be used to view physical signals and protocol analyzers can be used to view the exchange of message packets for timing protocols, such as PTP message packets, there exists a need for a test and measurement system that can analyze, correlate and report timing and timing error information associated with both physical digital signals and application layer timing protocols.

### SUMMARY

Methods, systems, and computer readable media for correlating and displaying physical layer and application layer timing information are disclosed. An example method for correlating and displaying physical layer and application layer timing information includes detecting, at a physical clock analyzer module on a test system, an edge transition of a physical layer waveform from a physical clock on a device under test (DUT). The method further includes generating, by the physical clock analyzer module, a timestamp for the detected edge transition. The method further includes determining, by the physical clock analyzer module, a physical clock timing error based on the timestamp for the detected edge transition. The method further includes exchanging, between the test system and the DUT, timing protocol messages, wherein the test system generates timestamps when transmitting or receiving the timing protocol messages and receives timestamp information from the DUT. The method further includes determining, by a timing protocol analyzer module on the test system, a protocol time based on the generated timestamps and the received timestamp information. The method further includes correlating, by the test system, the physical clock timing error and the protocol time to determine relative times of the physical clock timing error and the protocol time. The method further includes displaying, by a graphical user interface on the test system, a graphical representation of the relative times of the physical clock timing error and the protocol time.

According to another aspect of the subject matter described herein, the method includes receiving, by the test system, at least one signal indicating a time generated by at least one reference clock. The method further includes generating, by a reference clock module on the test system, a timestamp for each of the received at least one signal. The method further includes determining, by the test system, a reference clock time for each of the at least one reference clock based on the at least one timestamp for the at least one received signal. The method further includes correlating, by the test system, the physical clock timing error, the protocol time, and the at least one reference clock time to determine relative times of the physical clock timing error, the protocol time, and the at least one reference clock time. The method further includes displaying, by the graphical user interface, a graphical representation of the relative times of the physical clock timing error, the protocol time, and the at least one reference time.

According to another aspect of the method described herein, the graphical representation includes a graphical representation comparing one of the at least one relative reference time to the other relative times.

According to another aspect of the subject matter described herein, the method includes receiving, by the test system and from the DUT, the at least one signal indicating a time generated by the at least one reference clock.

According to another aspect of the subject matter described herein, the method includes receiving, by the test system and from at least one time reference source, the at least one signal indicating a time generated by the at least one reference clock.

According to another aspect of the method described herein, the at least one time reference source includes a first time reference source implementing a Global Navigation Satellite System (GNSS).

According to another aspect of the subject matter described herein, the method includes receiving, by the test system, user input selecting one of the at least one reference clock. The method further includes displaying, by the graphical user interface, a graphical representation comparing a relative reference time of the selected reference time to the other relative times.

According to another aspect of the method described herein, the graphical representation of the relative times includes a timing error of the physical clock timing error and a timing error of the protocol time.

According to another aspect of the method described herein, displaying the timing error of the physical clock and the timing error of the protocol time includes displaying the timing errors as time varying waveforms on an interface designed to mimic an oscilloscope display.

An example of a system for correlating and displaying physical layer and application layer timing information includes a test system configured for exchanging, with a device under test (DUT), timing protocol messages, wherein the test system generates timestamps when transmitting or receiving the timing protocol messages and receives timestamp information from the DUT. The test system includes a physical clock analyzer module configured for detecting an edge transition of a physical layer waveform from a physical clock on the DUT, generating a timestamp for the detected edge transition, and determining a physical clock timing error based on the timestamp for the detected edge transition. The test system further includes a timing protocol analyzer module configured for determining a protocol time based on the generated timestamps and the received timestamp information. The test system further includes a graphical user interface configured for displaying a graphical representation of relative times of the physical clock timing error and the protocol time. The test system is configured for correlating the physical clock timing error and the protocol time and determining the relative times of the physical clock timing error and the protocol time.

According to another aspect of the method described herein, the test system is configured for receiving at least one signal indicating a time generated by at least one reference clock. The test system is further configured for generating, by a reference clock module on the test system, a timestamp for each of the received at least one signal. The test system is further configured for determining a reference clock time for each of the at least one reference clock based on the at least one timestamp for the at least one received signal. The test system is further configured for correlating the physical clock timing error, the protocol time, and the at least one reference clock time to determine relative times of the physical clock timing error, the protocol time, and the at least one reference clock time. The test system is further configured for displaying, by the graphical user interface, a graphical representation of the relative times of the physical clock timing error, the protocol time, and the at least one reference time.

According to another aspect of the system described herein, the graphical representation includes a graphical representation comparing one of the at least one relative reference time to the other relative times.

According to another aspect of the system described herein, the test system is configured for receiving, from the DUT, the at least one signal indicating a time generated by the at least one reference clock.

According to another aspect of the system described herein, the test system is configured for receiving, from at least one time reference source, the at least one signal indicating a time generated by the at least one reference clock.

According to another aspect of the system described herein, the at least one time reference source includes a first time reference source implementing a Global Navigation Satellite System (GNSS).

According to another aspect of the system described herein, the test system is configured for receiving user input selecting one of the at least one reference clock and displaying, on the graphical user interface, a graphical representation comparing a relative reference time of the selected reference time to the other relative times.

According to another aspect of the system described herein, the graphical representation of the relative times includes a timing error of the physical clock timing error and a timing error of the protocol time.

According to another aspect of the system described herein, displaying the timing error of the physical clock and the timing error of the protocol time includes displaying the timing errors as time varying waveforms on an interface designed to mimic an oscilloscope display.

An example non-transitory computer readable medium has stored thereon executable instructions that when executed by at least one processor of at least one computer cause the at least one computer to perform steps including detecting an edge transition of a physical layer waveform from a physical clock on a device under test (DUT). The non-transitory computer readable medium has further instructions for generating a timestamp for the detected edge transition and determining a physical clock timing error based on the timestamp for the detected edge transition. The non-transitory computer readable medium has further instructions for exchanging, with the DUT, timing protocol messages, wherein the test system generates timestamps when transmitting or receiving the timing protocol messages and receives timestamp information from the DUT. The non-transitory computer readable medium has further instructions for determining a protocol time based on the generated timestamps and the received timestamp information. The non-transitory computer readable medium has further instructions for correlating the physical clock timing error and the protocol time to determine relative times of the physical clock timing error and the protocol time. The non-transitory computer readable medium has further instructions for displaying a graphical representation of the relative times of the physical clock timing error and the protocol time.

According to another aspect of the subject matter described herein, the non-transitory computer readable medium has instructions for receiving at least one signal indicating a time generated by at least one reference clock and generating a timestamp for each of the received at least one signal. The non-transitory computer readable medium has further instructions for determining a reference clock time for each of the at least one reference clock based on the at least one timestamp for the at least one received signal. The non-transitory computer readable medium has further instructions for correlating the physical clock timing error, the protocol time, and the at least one reference clock time to determine relative times of the physical clock timing error, the protocol time, and the at least one reference clock time. The non-transitory computer readable medium has further instructions for displaying a graphical representation of the relative times of the physical clock timing error, the protocol time, and the at least one reference time.

As used herein, the term “system(s) under test” or “SUT” refers to a system (e.g., a network or group of devices or node) or a device or node that is being tested or was tested (e.g., by a test system) or that is being analyzed or was analyzed (e.g., monitored by a monitoring system).

As used herein, the terms “function” and “module” refer to software in combination with hardware and/or firmware for implementing features described herein. In some embodiments, a module may include a field-programmable gate array (FPGA), an application-specific integrated circuit (ASIC), a programmable ASIC, a neural network processing unit, or a processor.

The subject matter described herein may be implemented in software in combination with hardware and/or firmware. For example, the subject matter described herein may be implemented in software executed by a processor. In one example implementation, the subject matter described herein may be implemented using a non-transitory computer readable medium having stored therein computer executable instructions that when executed by the processor of a computer control the computer to perform steps. Example computer readable media suitable for implementing the subject matter described herein include non-transitory devices, such as disk memory devices, chip memory devices, programmable logic devices, field-programmable gate arrays, and application specific integrated circuits. In addition, a computer readable medium that implements the subject matter described herein may be located on a single device or computer platform or may be distributed across multiple devices or computer platforms.

### BRIEF DESCRIPTION OF THE DRAWINGS

The subject matter described herein will now be explained with reference to the accompanying drawings of which:

FIG. 1 is a message flow diagram illustrating an example message exchange for clock synchronization using a timing protocol;

FIG. 2 is a block diagram illustrating an example system for correlating and displaying physical layer and application layer timing information;

FIG. 3 shows a graphical representation by a graphical user interface of physical layer and application timing information; and

FIG. 4 is a flow diagram illustrating an example method for correlating and displaying physical layer and application layer timing information.

### DETAILED DESCRIPTION

The subject matter described herein includes methods, systems, and computer readable media for correlating and displaying physical layer and application layer timing information. The test system provides a graphical representation of a physical waveform from a physical clock similar to an oscilloscope display, correlates timing information of a protocol time and possibly one or more reference clocks with the physical clock timing information and transposes the correlated timing information onto the physical waveform display so a user can view in a single graphical representation of timing information from various sources such as protocol time information from the application layer and physical time information from the physical layer. The test system timestamps a measured edge transition of a physical clock on a DUT and determines a time and/or a timing error of the physical clock. The test system also exchanges synchronization messages with the DUT per a timing protocol, e.g., PTP, and determines a protocol time and/or a protocol timing error. The determined timing information from the physical layer and the application layer may not necessarily be from the same time period, so the test system correlates the timing information and transposes the timing information on top of each other in a graphical representation which may mimic an oscilloscope display. The test system may receive at least one reference time from corresponding at least one time reference sources, either directly from the time sources or indirectly from the DUT and correlate the times of these time reference sources to include in the graphical representation for further comparisons. Timing information from one of the timing sources, such as a reference time from one of the time reference sources, may be zeroed in the graphical display for which the other timing information to be plotted in relation.

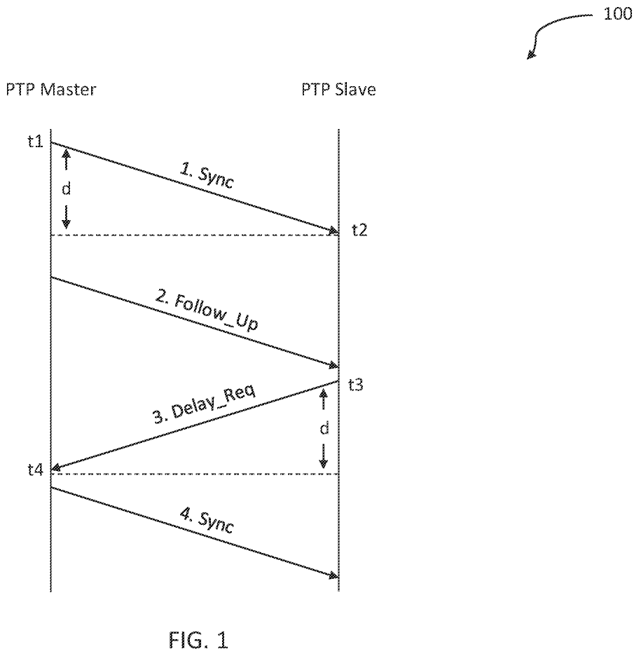

FIG. 1 is a message flow diagram illustrating an example message exchange for clock synchronization in the application layer of network devices using a timing protocol. The timing protocol in this example is Precision Time Protocol (PTP), specifically a two-step operation; however, it is understood that the subject matter may implement message exchanges using other timing protocols. The message exchange provides a network device with the slave clock the necessary information to determine and synchronize the time of the slave clock to the protocol time determined by the master clock. In message 1, the master clock, specifically a network device in a local area network (LAN) including the master clock and referred to herein as “PTP master,” sends a Sync message to the slave clock, specifically another network device in the LAN including the slave clock and referred to herein as “PTP slave.” The PTP master logs the transmit (Tx) timestamp t1 of the Sync message and the PTP slave logs the receive (Rx) timestamp t2 of the Sync message. In message 2, the PTP master then sends a Follow_Up message to the PTP slave with the t1 information. Thus, the PTP slave knows the time of the master clock when the PTP master sent the Sync message, t1, and the time of the slave clock when the PTP slave received the Sync message, t2. In a one-step operation, the master PTP is equipped to send t1 information in the Sync message and does not need to send the Follow_Up message.

In message 3, the PTP slave sends a Delay_Req message to the PTP master and logs the Tx timestamp t3 of the Delay_Req message. The PTP master logs the Rx timestamp t4 of the Delay_Req message. In message 4, the PTP master returns a Delay_Resp message to the PTP slave with the t4 information. Therefore, the PTP slave now also has the time of the slave clock when the Delay_Req message was sent, t3, and the time of the master clock when the PTP master received the Delay_Req message, t4. Disregarding potential differences between the delay in transmitting a message from the PTP master to the PTP slave and the delay in transmitting a message from the PTP slave to the PTP master by assuming they are equal or averaging the delays, the PTP slave is able to calculate the delay of a transmission as delay (d)=((t2−t1)+(t4−t3))/2. The PTP slave also has enough information from the message exchange to determine the offset between the slave clock time and master clock time, i.e., the protocol time, using the equation offset=((t2−t1)−(t4−t3))/2. The offset is the difference between the master clock and the slave clock at a given instance, wherein a positive offset indicates that the slave clock is running faster than the master clock and a negative offset indicates that the slave clock is running slower than the master clock.

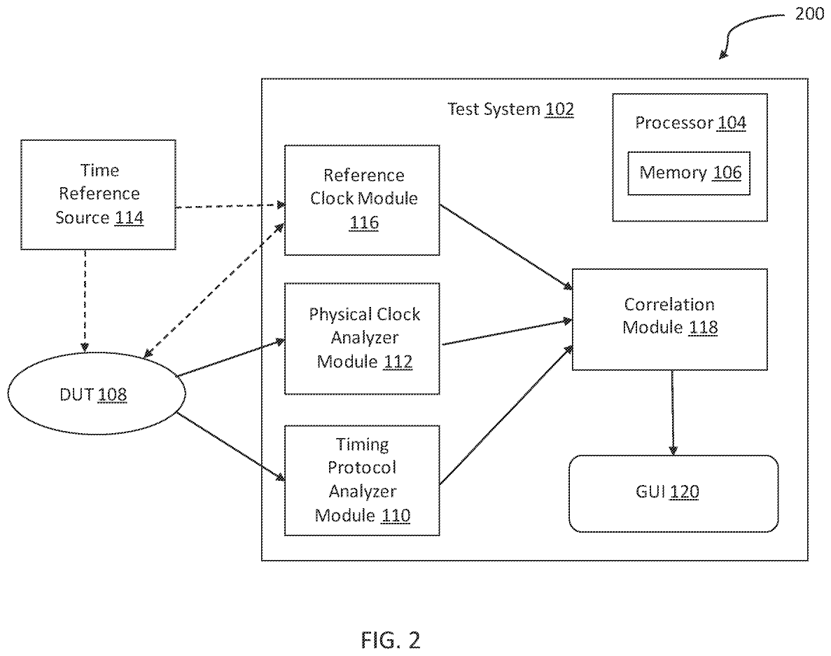

FIG. 2 is a block diagram illustrating a system 100 for correlating and displaying physical layer and application layer timing information. System 100 includes a test system 102. Test system 102 may include at least one hardware processor 104 and memory 106. Test system 102 may include a computing device such as, without limitation, a microcontroller, microprocessor, digital signal processor (DSP) and/or system on a chip (SoC) as described herein. Test system 102 may include a single computing device operating independently, or may include two or more computing devices operating in concert, in parallel, sequentially or the like. Test system 102 may include one or more central processing units (CPUs). Test system 102, using processor 104 and memory 106, may be configured to perform any of the steps described herein.

Test system 102 may be communicatively connected to a device under test (DUT) 108, such as by cable. It is understood that a DUT may be interchangeable with a system under test (SUT) in the subject matter herein. DUT 108 may include a serving gateway (SGW), a packet data network gateway (PGW), a firewall device, a router device, or any network device or network system with a physical clock, which may be a digital clock, and configured to implement a timing protocol. DUT 108 may include at least one hardware processor and a memory.

Test system 102 exchanges with DUT 108 timing protocol messages. Test system 102 may be configured to exchange timing protocol messages with DUT 108 that implements, for example without limitation, PTP, as shown in FIG. 1, Network Timing Protocol (NTP), or any other timing protocol configured for synchronizing clocks. When DUT 108 implements PTP, the timing protocol messages exchanged between test system 102 and the DUT 108 may include the messages shown in FIG. 1. Test system 102 may include a traffic generator configured to generate timing protocol messages to send to DUT 108. Test system 102 may transmit and receive messages from DUT 108 at a Tx port and an Rx port, respectively.

In some aspects of the disclosed subject matter, test system 102 may act as the PTP slave with a slave clock and DUT 108 may act as the PTP master with a master clock, wherein the DUT 108 sends to the test system 102 a Sync message. Test system 102 may prompt DUT 108 to commence the message exchange by at least emulating a slave PTP. DUT 108 may send the Sync messages to test system 102 and record the time of DUT's 108 clock when the Sync message was sent by logging a Tx timestamp t1. Test system 102 may record the time of test system's 102 clock when it received the Sync message by logging a Rx timestamp t2. If DUT 108 is not configured to implement a one-step operation where it includes the transmission time, i.e., Tx timestamp t1, in the Sync message, the DUT 108 can implement a two-step operation and send a Follow_Up message with the Tx timestamp t1 information to test system 102. Test system 102 may then send DUT 108 a Delay_Req message, recording the time of test system's 102 clock when it sent the Delay_Req message by logging a Tx timestamp t3. DUT 108 may record the time of DUT's 108 clock when it received the Delay_Req message by logging Rx timestamp t4. DUT 108 may then return a Delay_Req message including the Rx timestamp t4 information. Thus, test system 102 has t1, t2, t3, and t4 times and can determine the delay and/or offset using these times.

In some aspects of the disclosed subject matter, test system 102 may act as the PTP master with a master clock and DUT 108 may act as the PTP slave with a slave clock, in which case, after the message exchange between the test system 102 and the DUT 108 for clock synchronization, the test system 102 may pull from the DUT 108 the offset and/or delay determined by the DUT 108.

Test system 102 has a timing protocol analyzer module 110 configured to determine a protocol time. The determined protocol time may be the protocol time according to DUT's 108 clock. Timing protocol analyzer module 110 may determine the offset between the clocks of the test system 102 and DUT 108 and the delay in transmitting the messages. Notably, timing protocol analyzer module 110 may determine the protocol time according to DUT 108's clock using the protocol time of test system 102's clock and the determined offset. Timing protocol analyzer module 110 may determine a protocol timing error of DUT's 108 clock in relation to test system's 102 clock, which is the offset when the DUT 108 is the PTP slave and the negative offset when the DUT 108 is the PTP master. Thus, the determined protocol timing error is negative when DUT's 108 clock is slow in relation to test system's 102 clock and positive when the DUT's 108 clock is fast in relation to the test system's 102 clock.

Test system 102 may include a physical clock analyzer module 112 that detects an edge transition of a physical layer waveform from a physical clock on DUT 108. An edge transition is a rising edge or a falling edge of a waveform. The physical clock may include any physical clock used by network devices, including quartz clocks and atomic clocks. The physical clock can be configured to transmit the physical layer waveform at a specific frequency. For example, the physical clock may transmit the physical layer waveform at 0.5 Hz, 1 Hz, i.e., one pulse per second (1PPS), 2 Hz, or any other specific frequency. Generally, DUT 108 can compare when it receives a physical layer waveform from the physical clock to a reference clock to determine the time.

In practice, however, the physical clock does not consistently transmit the physical layer waveform at exactly the specific frequency and phase, which can be referred to respectively as the expected frequency and phase. For example, the physical clock may transmit the physical layer waveform earlier or later than the expected signal (which represents a phase offset) and/or with a frequency that differs from the expected frequency. The time error for the physical clock is referred to as the time interval error (TIE), which is the expected time of a specific feature, i.e., edge transition, in a physical layer waveform less the actual time the feature was detected. Therefore, an early or fast detected edge transition has a positive TIE and a late or slow detected edge transition has a negative TIE.

Physical clock analyzer module 112 can determine the expected time of the edge transition of the physical layer waveform based on the reference clock used and the periodicity, or inverse expected frequency, of the physical clock. For example, if the physical clock includes a 1PPS physical clock, the reference clock is an atomic or other clock that runs in seconds, and the two clocks are synchronized, then the expected time of the edge transition of the physical layer waveform is at the top of each second of the reference clock. In an example where the physical clock transmits a physical layer waveform at 2 Hz, the expected time of an edge transition of the physical layer waveform is at the top of each second and at the midpoint between seconds. The reference clock may be a time reference source 114, described below, which defines a reference time.

Physical clock analyzer module 112 can determine the actual or measured time of the edge transition of the physical layer waveform by detecting the edge transition and generating a timestamp when it detects the edge transition of the received physical layer waveform. Physical clock analyzer module 112 may determine a time error, i.e., TIE, of the physical clock based on the timestamp of the detected edge transition. Physical clock analyzer module 112 may determine which expected waveform corresponds to the detected edge transition of the physical layer waveform based on the timestamp of the detected edge transition. Specifically, physical clock analyzer module 112 may determine that the expected time of the detected edge transition by identifying the nearest expected time to the timestamp of the detected edge transition up to within half of the expected period. For example, if the physical clock is expected to transmit a waveform at 1 Hz, then the expected time is at the top of each second, and physical clock analyzer module 112 can determine that the expected time for the detected edge transition is the top of the second nearest the timestamp of the detected edge transition. Similarly, if the physical clock is expected to transmit a waveform at 2 Hz, which is an expected 0.5 second period, and physical clock analyzer module 112 timestamps a detected edge transition at n.4 seconds, where n is an integer, the physical clock analyzer module 112 determines that the expected time for the edge transition within 0.25 seconds, half of the expected period, is n.5 seconds and the detected edge transition is early by 0.1 seconds, giving a TIE of 0.1 seconds.

Test system 102 and/or DUT 108 may receive a reference time from a time reference source 114. In some aspects of the described subject matter, time reference source 114 sends a signal indicating a reference time to DUT 108 and the DUT 108 may share the reference time with test system 102 by sending a signal indicating the reference time to a reference clock module 116 in the test system 102. In other aspects of the described subject matter, reference clock module 116 can receive the reference time directly from time reference source 114 and the test system 102 may share the reference time with DUT 108 by sending a signal indicating the reference time to the DUT 108. In other aspects of the described subject matter, time reference source 114 may send signals indicating the reference time to both DUT 108 and reference clock module 116. Time reference source 114 may implement a Global Navigation Satellite System (GNSS), such as the Global Positioning System (GPS), Time of Day (ToD) clock, clock implementing time and phase synchronization per G.8271 Recommendation of International Telecommunication Union (ITU), or any other device that generates a time.

Test system 102 may include a correlation module 118 that receives and correlates the reference time from reference clock module 116, the TIE from the physical clock analyzer module 112, and/or the protocol time according to DUT 108 and/or timing error of the protocol time according to the DUT 108. In some aspects of the described subject matter, the timing information received from reference clock module 116, physical clock analyzer module 112, and/or timing protocol analyzer module 110 may not correspond to the same time period, but may instead simply be from a most recent measurement and determination of timing information. The protocol time and/or protocol timing error determined by timing protocol analyzer module 110 may have been measured during a first period of time, while the TIE was measured by the physical clock analyzer module 116 during a second period of time separate from the first period, and correlation module 118 may correlate the timing information. As an example, the protocol time and/or protocol timing error may correspond to reference time 8:37 and 5 seconds wherein the determined protocol time was 4 nanoseconds earlier than 8:37 and 5 seconds, while the TIE corresponds to reference time 8:37 and 8 seconds wherein the determined physical clock time (and thus the physical clock timing error) was 2 nanoseconds later than 8:37 and 8 seconds. Correlation module 118 may correlate and compare the timing information as if they correspond to a same period, namely that the protocol time is 4 nanosecond slower than the reference clock, the physical clock is 2 nanoseconds faster than the reference clock, and the protocol time is 6 nanoseconds slower than the physical clock.

Test system includes a graphical user interface (GUI) 120. GUI 120 can receive the correlations of the timing information from correlation module 118 and display a graphical representation of the correlated timing information from the physical layer and the application layer, such as correlated protocol time and physical clock timing error.

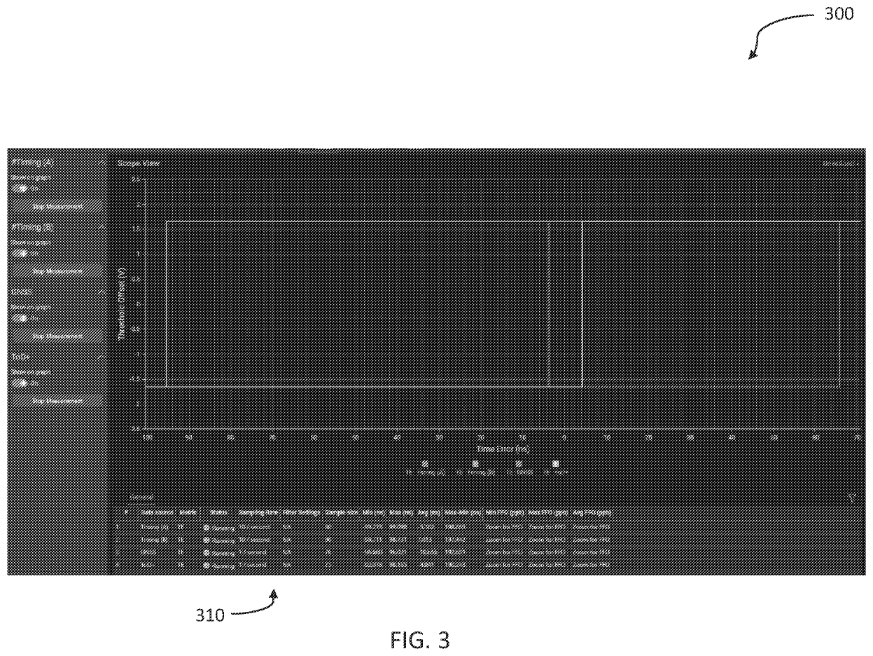

FIG. 3 shows a graphical representation 300 by a graphical user interface of physical layer and application timing information. Graphical representation 300 can include a display of the relative times of the physical clock timing error, such as the TIE, and the protocol time. The displayed relative times may include a timing error the protocol time, i.e., the protocol timing error. Graphical representation 300 may display correlated times and/or timing errors as time varying waveforms on an interface designed to mimic an oscilloscope display. In the example shown in FIG. 3, graphical representation 300 includes correlated times of GNSS and ToD+, but it is understood that graphical representation 300 may include different, fewer, or more correlated times such as 10 Hz, 1PPS, and PTP. Graphical representation 300 may include an x-axis as a time metric, such as nanoseconds, representing relative time between the correlated times. Graphical representation 300 may also include a y-axis to graph another metric. In one aspect of the described subject matter, the y-axis can represent a measured voltage from a timing signal. Graphical representation 300 may display the correlated times and/or timing errors of the physical clock, the protocol time, and/or one or more reference times as time varying waveforms on an interface designed to mimic an oscilloscope display. The correlated times may be displayed similarly to how oscilloscopes generally display a measured physical waveform from a physical clock, namely with two flat horizontal lines at different heights, designating different measured voltages, connected by a vertical or an approximately vertical line, which is the edge transition. Although the correlated times other than the physical clock time signal do not necessarily have an edge transition between measured low and high voltages, they may similarly be displayed wherein the vertical line identified the determined correlated time.

In some aspects of the described subject matter, graphical representation 300 can also include one or more reference clock times correlated with the physical clock timing error and the protocol time. The correlated times, i.e., the correlated physical clock timing error and the protocol time and possibly one or more correlated reference times, may be displayed in relation to a specific time by setting one of the correlated time that is displayed at a relative time of zero on the x-axis and plotting the remaining correlated times based on how fast or slow the times are compared to the specific time. The specific correlated time to which the other correlated times are compared can be one of the reference times, the protocol time, or the physical clock timing error. For example, if the specific correlated time to which the other correlated times are compared is a correlated reference time from a GNSS clock, then the GNSS clock time is plotted at time zero on the x-axis and the correlated physical clock timing error, protocol time, and any other reference times are plotted according to how fast or slow they are in relation to the correlated GNSS clock time. In one aspect of the described subject matter, the specific correlated time to which the other correlated times are compared may be selected via user input into the test system. In aspects of the described subject matter where graphical representation 300 includes timing errors, the timing errors may be plotted without a specific correlated time set to zero for comparison. For example, if the determined TIE and protocol timing error is 3 nanoseconds and −2 nanoseconds, respectively, then TIE would be plotted at 3 nanoseconds on the x-axis and the protocol timing error would be plotted at −2 nanoseconds on the x-axis.

Each signal's correlated timing error may be distinguishable by being plotted with a different color, line pattern, or other distinguishable trait. Graphical representation 300 may include a list 310 of the correlated signal's time errors identifying the respective distinguishable traits. List 310 may include the status of whether each correlated signal is running, the sampling rate, sampling size, and the determined minimum, maximum, and average correlated timing errors. In some aspects of the described subject matter, positive time error to negative time error can be plotted on the x-axis from left to right to show correlated fast edges on the left and correlated slow edges on the right. By placing the timing errors, such as the TIE, decreasing toward the right, a traditional oscilloscope that shows time moving to the right is mimicked. In other aspects of the described subject matter, negative timing errors to positive timing errors can be plotted on the x-axis from left to right, thus the earlier or faster signals appear to the right of later or slower signals.

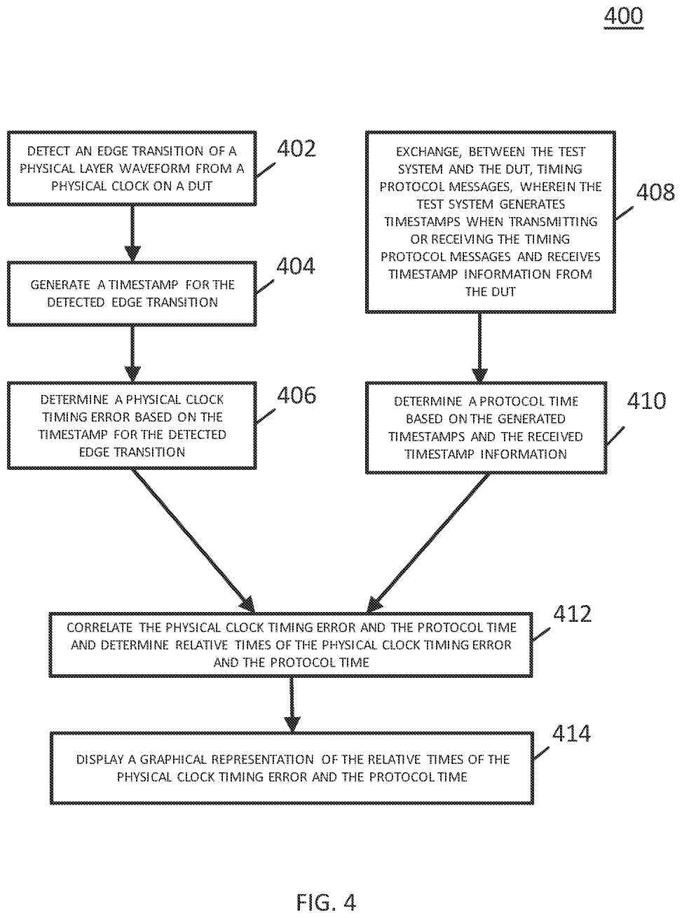

FIG. 4 is a flow diagram illustrating an example method 400 for correlating and displaying physical layer and application layer timing information. At step 402, an edge transition of a physical layer waveform from a physical clock on a device under test (DUT) is detected at a physical clock analyzer module on a test system.

At step 404, a timestamp for the detected edge transition is generated by the physical clock analyzer module.

At step 406, the physical clock analyzer module determines a physical clock timing error based on the timestamp for the detected edge transition.

At step 408, timing protocol messages are exchanged between the test system and the DUT, wherein the test system generates timestamps when transmitting or receiving the timing protocol messages and receives timestamp information from the DUT.

At step 410, a timing protocol analyzer module on the test system determines a protocol time based on the generated timestamps and the received timestamp information.

The test system may further receive at least one signal indicating a time generated by at least one reference clock. The test system may receive the at least one signal from the DUT or directly from the reference clock. The time reference source may include a first time reference source implementing a Global Navigation Satellite System (GNSS), such as the Global Positioning System (GPS). A reference clock module on the test system may generate a timestamp for each of the received at least one signal. The test system may determine a reference clock time for each of the at least one reference clock based on the at least one timestamp for the at least one received signal.

At step 412, the test system correlates the physical clock timing error and the protocol time to determine relative times of the physical clock timing error and the protocol time. If the test system receives signals from a reference clock, the test system may correlate the physical clock timing error, the protocol time, and the at least one reference clock time to determine relative times of the physical clock timing error, the protocol time, and the at least one reference clock time.

At step 414, a graphical user interface on the test system displays a graphical representation of the relative times of the physical clock timing error and the protocol time. The graphical representation of the relative times may include a protocol timing error. Displaying the timing error of the physical clock and the timing error of the protocol time may include displaying the timing errors as time varying waveforms on an interface designed to mimic an oscilloscope display. The graphical user interface may also display a graphical representation of the relative time of the at least one reference clock time. The graphical representation may include a graphical representation comparing one of the at least one relative reference time to the other relative times. The test system my receive user input selecting one of the at least one reference clock, and the graphical user interface may display a graphical representation comparing a relative reference time of the selected reference time to the other relative times.

It is understood that steps 402-406 can be conducted independently of and/or in parallel with steps 408-410. Similarly, receiving a timing signal directly or indirectly from a reference clock, such as time reference source, and determining a reference clock time can be conducted independently of and/or in parallel with steps 402-406 and steps 408-410. It will be appreciated that method 400 is for illustrative purposes and that different and/or additional actions may be used. It will also be appreciated that various actions described herein may occur in a different order or sequence. It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for correlating and displaying physical layer and application layer timing information, the method comprising:
detecting, at a physical clock analyzer module on a test system, an edge transition of a physical layer waveform from a physical clock on a device under test (DUT);
generating, by the physical clock analyzer module, a timestamp for the detected edge transition;
determining, by the physical clock analyzer module, a physical clock timing error based on the timestamp for the detected edge transition;
exchanging, between the test system and the DUT, timing protocol messages, wherein the test system generates timestamps when transmitting or receiving the timing protocol messages and receives timestamp information from the DUT;
determining, by a timing protocol analyzer module on the test system, a protocol time based on the generated timestamps and the received timestamp information;
correlating, by the test system, the physical clock timing error and the protocol time to determine relative times of the physical clock timing error and the protocol time; and
displaying, by a graphical user interface on the test system, a graphical representation of the relative times of the physical clock timing error and the protocol time.

2. The method of claim 1 comprising:
receiving, by the test system, at least one signal indicating a time generated by at least one reference clock;
generating, by a reference clock module on the test system, a timestamp for each of the received at least one signal;
determining, by the test system, a reference clock time for each of the at least one reference clock based on the at least one timestamp for the at least one received signal;
correlating, by the test system, the physical clock timing error, the protocol time, and the at least one reference clock time to determine relative times of the physical clock timing error, the protocol time, and the at least one reference clock time; and
displaying, by the graphical user interface, a graphical representation of the relative times of the physical clock timing error, the protocol time, and the at least one reference time.

3. The method of claim 2, wherein the graphical representation includes a graphical representation comparing one of the at least one relative reference time to the other relative times.

4. The method of claim 2 comprising receiving, by the test system and from the DUT, the at least one signal indicating a time generated by the at least one reference clock.

5. The method of claim 2 comprising receiving, by the test system and from at least one time reference source, the at least one signal indicating a time generated by the at least one reference clock.

6. The method of claim 5 wherein the at least one time reference source includes a first time reference source implementing a Global Navigation Satellite System (GNSS).

7. The method of claim 2 comprising:
receiving, by the test system, user input selecting one of the at least one reference clock; and
displaying, by the graphical user interface, a graphical representation comparing a relative reference time of the selected reference time to the other relative times.

8. The method of claim 1 wherein the graphical representation of the relative times includes a protocol timing error.

9. The method of claim 8 wherein displaying the physical clock timing error and the protocol timing error includes displaying the timing errors as time varying waveforms on an interface designed to mimic an oscilloscope display.

10. A system for correlating and displaying physical layer and application layer timing information, the system comprising:
a test system configured for exchanging, with a device under test (DUT), timing protocol messages, wherein the test system generates timestamps when transmitting or receiving the timing protocol messages and receives timestamp information from the DUT, the test system comprising:
a physical clock analyzer module configured for:
detecting an edge transition of a physical layer waveform from a physical clock on the DUT;
generating a timestamp for the detected edge transition; and
determining a physical clock timing error based on the timestamp for the detected edge transition;
a timing protocol analyzer module configured for:
determining a protocol time based on the generated timestamps and the received timestamp information; and
a graphical user interface configured for displaying a graphical representation of relative times of the physical clock timing error and the protocol time;
wherein the test system is configured for correlating the physical clock timing error and the protocol time and determining the relative times of the physical clock timing error and the protocol time.

11. The system of claim 11 wherein the test system is configured for:
receiving at least one signal indicating a time generated by at least one reference clock;
generating, by a reference clock module on the test system, a timestamp for each of the received at least one signal;
determining a reference clock time for each of the at least one reference clock based on the at least one timestamp for the at least one received signal;
correlating the physical clock timing error, the protocol time, and the at least one reference clock time to determine relative times of the physical clock timing error, the protocol time, and the at least one reference clock time; and
displaying, by the graphical user interface, a graphical representation of the relative times of the physical clock timing error, the protocol time, and the at least one reference time.

12. The system of claim 12, wherein the graphical representation includes a graphical representation comparing one of the at least one relative reference time to the other relative times.

13. The system of claim 12 wherein the test system is configured for receiving, from the DUT, the at least one signal indicating a time generated by the at least one reference clock.

14. The system of claim 12 wherein the test system is configured for receiving, from at least one time reference source, the at least one signal indicating a time generated by the at least one reference clock.

15. The system of claim 15 wherein the at least one time reference source includes a first time reference source implementing a Global Navigation Satellite System (GNSS).

16. The system of claim 12 wherein the test system is configured for:
receiving user input selecting one of the at least one reference clock; and
displaying, on the graphical user interface, a graphical representation comparing a relative reference time of the selected reference time to the other relative times.

17. The system of claim 10 wherein the graphical representation of the relative times includes a protocol timing error.

18. The system of claim 17 wherein displaying the physical clock timing error and the protocol timing error includes displaying the timing errors as time varying waveforms on an interface designed to mimic an oscilloscope display.

19. A non-transitory computer readable medium having stored thereon executable instructions that when executed by at least one processor of at least one computer cause the at least one computer to perform steps comprising:
detecting an edge transition of a physical layer waveform from a physical clock on a device under test (DUT);
generating a timestamp for the detected edge transition;
determining a physical clock timing error based on the timestamp for the detected edge transition;
exchanging, with the DUT, timing protocol messages, wherein the test system generates timestamps when transmitting or receiving the timing protocol messages and receives timestamp information from the DUT;
determining a protocol time based on the generated timestamps and the received timestamp information;
correlating the physical clock timing error and the protocol time to determine relative times of the physical clock timing error and the protocol time; and
displaying a graphical representation of the relative times of the physical clock timing error and the protocol time.

20. The non-transitory computer readable medium of claim 19, the steps comprising:
Receiving at least one signal indicating a time generated by at least one reference clock;
generating a timestamp for each of the received at least one signal;
determining a reference clock time for each of the at least one reference clock based on the at least one timestamp for the at least one received signal;
correlating the physical clock timing error, the protocol time, and the at least one reference clock time to determine relative times of the physical clock timing error, the protocol time, and the at least one reference clock time; and
displaying a graphical representation of the relative times of the physical clock timing error, the protocol time, and the at least one reference time.
